(19) United States
(12) Patent Application Publication
(10) Pub. No.: US 2026/0260285 A1
(43) Pub. Date: Sep. 3, 2026

(54) ARRANGEMENT MANAGEMENT SYSTEM, ARRANGEMENT MANAGEMENT METHOD, AND RECORDING MEDIUM

(71) Applicant: NEC Corporation, Tokyo (JP)

(72) Inventors: Hideo URAI, Tokyo (JP); Kanako HATAYAMA, Tokyo (JP)

(73) Assignee: NEC Corporation, Tokyo (JP)

(21) Appl. No.: 19/459,139

(22) Filed: Jan. 26, 2026

(30) Foreign Application Priority Data
Mar. 3, 2025 (JP) 2025-032585

(51) Int. Cl. G06Q 30/0601; G06Q 20/20

(52) U.S. Cl. CPC G06Q 30/0639; G06Q 20/203; G06Q 20/208

(57) ABSTRACT

An arrangement management system according to the present disclosure includes at least one memory storing instructions; and at least one processor configured to execute the instructions to: acquire stored product information for specifying a product requested by a customer to be stored in a designated store, when a store clerk stores the product, record, in response to reading of a location code indicating location information for specifying a storage location where the product is arranged among location codes respectively attached to a plurality of storage locations, the acquired stored product information and the location information in association with each other, and notify the store clerk of the storage location based on the location information recorded in association with the stored product information related to the customer, when the customer visits the store.

This application is based upon and claims the benefit of priority from Japanese patent application No. 2025-032585, filed on March 3, 2025, the disclosure of which is incorporated herein in its entirety by reference.

### TECHNICAL FIELD

The present disclosure relates to an arrangement management system and the like.

### BACKGROUND ART

With the introduction of electronic commerce (Electronic Commerce, EC) and omni channels, online product purchase and product reservation have become widespread. A customer can pick up a product purchased on an EC site at a store. In addition, the customer can also request that the product be reserved at a designated store or that the product be ordered from another store and held at a designated store via a store's website.

JP 2023-013124 A discloses a shopping system that allows a product purchased using an EC site to be picked up at a designated store. In JP 2023-013124 A, a store clerk performs an operation of associating an order number corresponding to a stored product with a number of a storage opening storing the product.

### SUMMARY

An arrangement management system according to an aspect of the present disclosure includes at least one memory storing instructions, and

at least one processor configured to execute the instructions to: acquire stored product information for specifying a product requested by a customer to be stored in a designated store, when a store clerk stores the product, record, in response to reading of a location code indicating location information for specifying a storage location where the product is arranged among location codes respectively attached to a plurality of storage locations, the acquired stored product information and the location information in association with each other, and notify the store clerk of the storage location based on the location information recorded in association with the stored product information related to the customer, when the customer visits the store.

An arrangement management method according to an aspect of the present disclosure includes acquiring stored product information for specifying a product requested by a customer to be stored in a designated store, when a store clerk stores the product, recording, in response to reading of a location code indicating location information for specifying a storage location where the product is arranged among location codes respectively attached to a plurality of storage locations, the acquired stored product information and the location information in association with each other, and notifying the store clerk of the storage location based on the location information recorded in association with the stored product information related to the customer, when the customer visits the store.

A non-transitory computer readable recording medium according to an aspect of the present disclosure stores a program that causes a computer to execute processing of acquiring stored product information for specifying a product requested by a customer to be stored in a designated store, when a store clerk stores the product, recording, in response to reading of a location code indicating location information for specifying a storage location where the product is arranged among location codes respectively attached to a plurality of storage locations, the acquired stored product information and the location information in association with each other, and notifying the store clerk of the storage location based on the location information recorded in association with the stored product information related to the customer, when the customer visits the store.

### BRIEF DESCRIPTION OF THE DRAWINGS

Exemplary features and advantages of the present disclosure will become apparent from the following detailed description when taken with the accompanying drawings in which:

FIG. 1 is an explanatory diagram illustrating an example of connection between an arrangement management system and other devices;

FIG. 2 is a diagram illustrating an example of an order screen;

FIG. 3 is a block diagram illustrating a configuration example of the arrangement management system;

FIG. 4 is a diagram illustrating an example of a storage location;

FIG. 5 is a diagram illustrating an example of a storage location registration screen;

FIG. 6 is a diagram illustrating an example of a product retrieval request screen;

FIG. 7 is a flowchart illustrating an operation example of the arrangement management system;

FIG. 8 is a block diagram illustrating a configuration example of an arrangement management system;

FIG. 9 is a flowchart illustrating an operation example of the arrangement management system;

FIG. 10 is a block diagram illustrating a configuration example of an arrangement management system;

FIG. 11 is a flowchart illustrating an operation example of the arrangement management system; and

FIG. 12 is a block diagram illustrating an example of a hardware configuration of a computer.

### EXAMPLE EMBODIMENT

### First Example Embodiment

The present disclosure describes an arrangement management system for efficiently managing a storage location of a product when the product is stored for a specific customer in a store. The present disclosure is applicable to management of a reserved product and management of a purchased product. The reserved product includes a product already in stock at the store, a product to be ordered from another store, and a product to be ordered from a warehouse of an EC site. The customer checks the actual reserved product and considers whether to purchase it. For example, the customer checks color, size feel, feel of use, function, and the like of the product. The purchased product is a product that the customer has purchased online and has selected to pick up at the store. These products need to be properly managed until the customer picks them up at the store. Note that the present disclosure can be achieved by a configuration that manages only either the reserved product or the purchased product or a configuration that manages both the products.

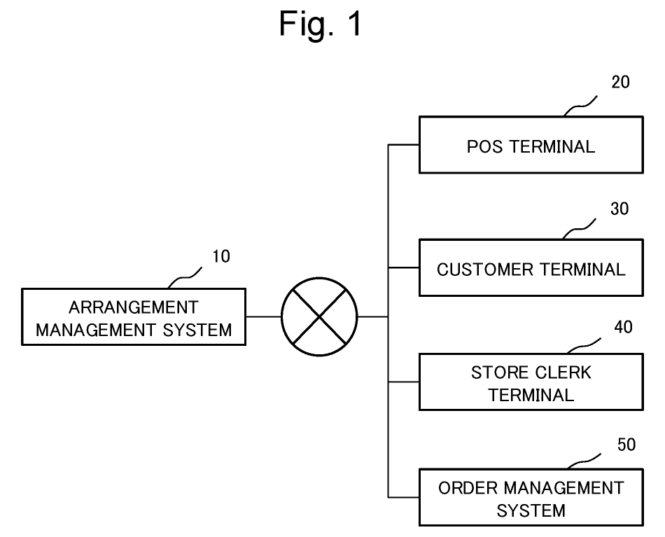

An example of connection between an arrangement management system 10 and other devices according to the present disclosure will be described with reference to FIG. 1. The arrangement management system 10 is communicably connected to a POS terminal 20, a customer terminal 30, a store clerk terminal 40, and an order management system 50. These devices can communicate with each other via a wired or wireless network.

The POS terminal 20 is a terminal for performing product sales and payment processing in a store, and has a function of reading a bar code of a product and a code of a storage location.

The customer terminal 30 is a terminal operated by a customer. A smartphone or a personal computer owned by the customer is mainly assumed as the customer terminal 30, but the present disclosure is not limited to this. The customer can use the customer terminal 30 to request order or reservation of a product, request in-store pickup, or the like.

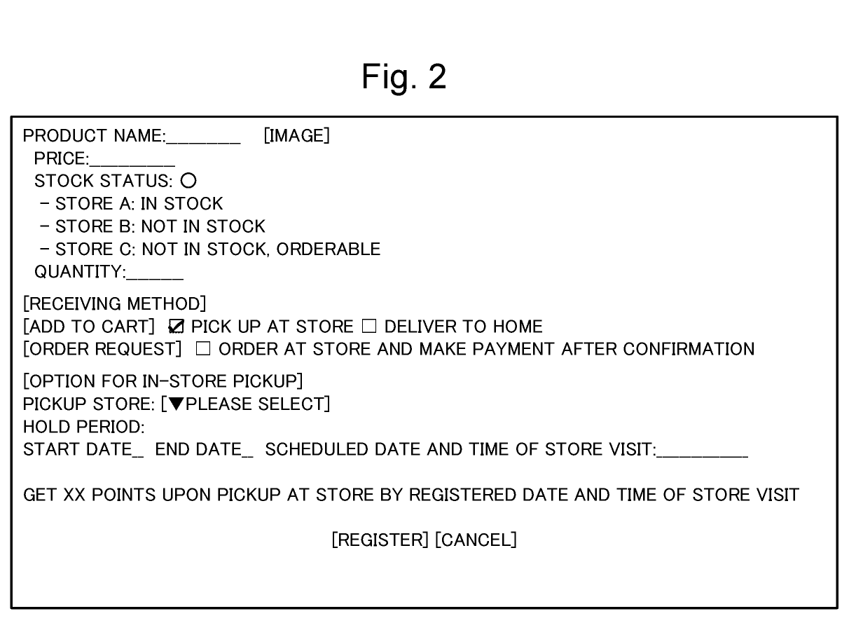

An example of an order screen displayed on the customer terminal 30 will be described with reference to FIG. 2. In FIG. 2, a screen including detailed information on a product and order options is displayed. This screen is displayed, for example, when a customer selects a specific product from a plurality of products. In an upper part of the screen, a product name, a price, and a product image are displayed. Below, a stock status of each store is clearly displayed. For example, by displaying the stock status of each store, the customer can confirm at which store the customer can immediately obtain the product. The customer can enter a desired quantity and select a receiving method. Next to “add to cart ”, there are options of “in-store pickup” and “delivery to home”. In addition, next to “order request”, there is also an option of “order at store and make payment after confirmation”. When in-store pickup is selected, additional options are displayed. When the customer selects a pickup store from a drop-down list, after the selection, a hold period (start date and end date) is displayed in consideration of a period required for preparation of the product. Further, the customer can designate a scheduled date and time of store visit. Furthermore, in order to recommend that the customer promptly picks up the product, an incentive that “get XX points upon pickup at store by registered date and time of store visit” is also presented. There are “register” and “cancel” buttons at a lower part of the screen, and the customer can confirm or cancel the selected contents.

In a case where the customer selects pickup or hold at the store, a storage request is transmitted from the customer terminal 30 to the order management system 50. The storage request includes a designated store, product information, a customer ID, and the like.

The store clerk terminal 40 is a terminal used by a store clerk. The store clerk terminal 40 is used as a customer service terminal different from the POS terminal 20. A tablet-type mobile terminal and the like is mainly assumed as the store clerk terminal 40, but the present disclosure is not limited to this. A store clerk can use the store clerk terminal 40 to manage the storage location of the product, receive support for customer handling, and the like. The store clerk terminal 40 has a code reader function. This function can be achieved using a built-in camera. Depending on a store, a radio frequency (RF) tag may be used. In this case, the store clerk terminal 40 is equipped with an RF reader that reads a tag by near field communication instead of or in addition to the camera.

The order management system 50 manages online order processing, stock confirmation, delivery arrangement, management of product transfer between stores, and the like. In addition, the order management system 50 manages an order history and a preference of a customer, and can also be used to provide a personalized service. Upon receiving the storage request from the customer terminal 30, the order management system 50 transmits a notification to, for example, the POS terminal 20 or the store

clerk terminal 40 of the designated pickup store. The store clerk performs work based on this notification. For example, the store clerk performs work such as retrieving a stock of the store or receiving a stock from another store, and arranging the stock in a predetermined storage location. The order management system 50 makes a delivery request to an EC warehouse or other stores as necessary.

Note that each of the above-described devices is not necessarily implemented as separate hardware. For example, some or all of the functions of the arrangement management system 10 and the POS terminal 20 may be implemented by common hardware. In addition, the functions of the store clerk terminal 40 can be integrated into the POS terminal 20. Also, the functions of the arrangement management system 10 can be integrated into the order management system 50.

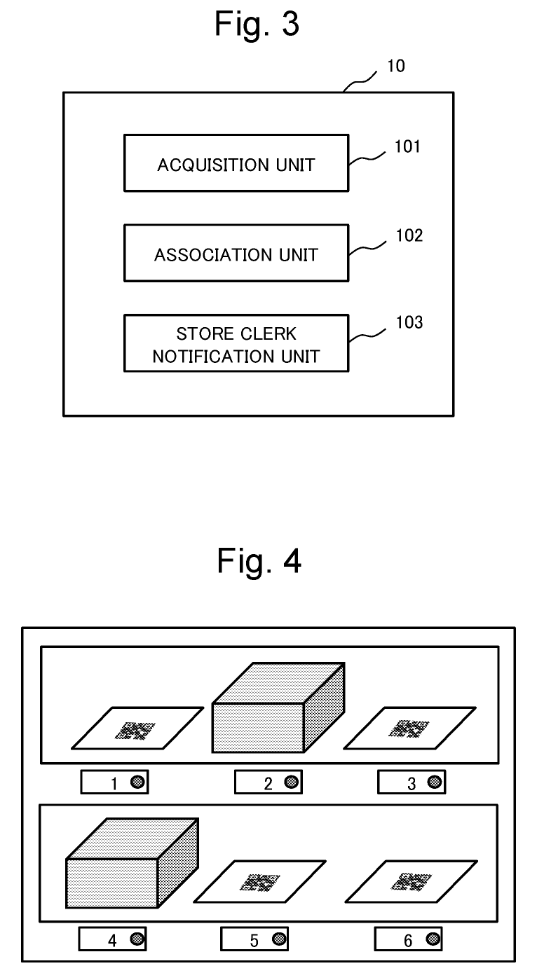

A configuration example of the arrangement management system 10 according to the present disclosure will be described with reference to FIG. 3. In one example, the arrangement management system 10 includes an acquisition unit 101, an association unit 102, and a store clerk notification unit 103.

The acquisition unit 101 acquires stored product information for specifying a product requested by a customer to be stored in a designated store. The stored product information includes, for example, a product name, a product code, an order number, and the like. The stored product information may include information on a plurality of products ordered simultaneously by the customer. Also, the stored product information may include a customer identifier (ID) that uniquely identifies the customer. In a case where both a reserved product and a purchased product are managed, the stored product information includes whether the product has been purchased.

For example, the acquisition unit 101 acquires the stored product information from the order management system 50. In one example, the acquisition unit 101 acquires the stored product information on a product displayed on the POS terminal 20 or the store clerk terminal 40 by notification from the order management system 50. The store clerk selects stored product information of a specific customer on the screen, and the store clerk terminal 40 or the like transmits the selection to the acquisition unit 101. In another example, the acquisition unit 101 acquires the stored product information in response to the store clerk reading a stored product code attached to the product or an order slip. This code is displayed in the form of, for example, a bar code or a two-dimensional code and indicates the stored product information of the specific customer, and the corresponding stored product information is specified by reading the code. The order slip is attached to the product or put together in a bag or box of the product.

The association unit 102 records the stored product information acquired by the acquisition unit 101 and location information for specifying a location where the product is arranged in association with each other. A location code indicating the location information is attached to each of a plurality of storage locations of a store. The location code is displayed in the storage location as, for example, a bar code or a two-dimensional code. Alternatively, an RF tag indicating the location code may be attached to the storage location. The association unit 102 records the stored product information and the location information in association with each other, in response to the store clerk reading the location code when arranging the product. The associated information is recorded, for example, in a database in the arrangement management system 10.

The association unit 102 also performs correction processing in a case where a product is moved or is erroneously arranged. For example, in a case where a location code of an already associated product is read again, the association unit 102 updates with new location information.

An example of a storage location in a store will be described with reference to FIG. 4. For example, a storage shelf as illustrated in FIG. 4 is installed in a backyard of the store or behind a cash register. This shelf has a plurality of sections, and numbers 1 to 6 are displayed. A location code for uniquely identifying its storage location is attached to an arrangement surface of each section. In this example, the location code is displayed as a two-dimensional code, but it can also be implemented in other forms, such as a bar code. The location code can also be displayed on an electronic shelf label installed at each arrangement location. In the example of FIG. 4, a state in which products are arranged in the sections of numbers 2 and 4 is illustrated. When arranging the product, the store clerk associates the product with the arrangement location by reading the two-dimensional code of the corresponding section. The storage location does not necessarily need to be such a shelf. For example, a locker-style storage, a hanger rack, or a part of a display shelf of a store can be used as the storage location.

In addition, the location code indicating the storage location does not necessarily need to be visually displayed. For example, a method of incorporating an RF tag in an electronic shelf label and reading the location code by near field communication is also conceivable. In this case, by rewriting the display of the electronic shelf label, display contents can be dynamically changed according to a storage status. The storage status includes, for example, “vacant” in a usable state, “product already arranged”, “pickup preparation completed” when a customer visits a store, and the like. Furthermore, some electronic shelf labels are provided with light emitting devices, and it is also possible to inform a vacant available position or a position of a specific product by light.

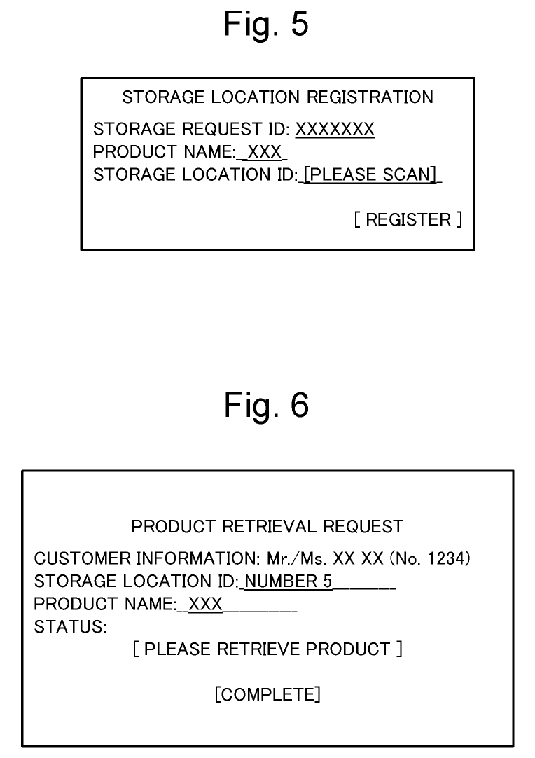

An example of a storage location registration screen will be described with reference to FIG. 5. This screen is displayed on the store clerk terminal 40 when a store clerk associates a product storage location with a product acquired by the acquisition unit 101. The screen of FIG. 5 includes a storage request ID, a product name, a storage location ID, and a registration button. The storage request ID is an identifier assigned to uniquely identify stored product information. The product name is a name of the product to be stored. The storage location ID is a field for inputting the identifier of the storage location in which the product is arranged. After arranging the product, the store clerk scans a location code of a location where the product is arranged. The scanned location code is input into the field. Thereafter, when the store clerk presses a “register” button, the association between the product and the storage location is recorded. This method saves the trouble of manual input and reduces the risk of input errors.

Note that, although not displayed in FIG. 5, in a case where stored product information is acquired by scanning a code attached to a product or an order slip, a message that “please scan stored product code” is displayed on the screen. The stored product information is acquired from the scanned stored product code, and is input into the corresponding field on the screen.

The association unit 102 generally associates one piece of stored product information with one piece of location information. However, a plurality of pieces of location information may be associated with one piece of stored product information. For example, it is used when a plurality of products of the same customer are arranged in a plurality of sections. Also, a plurality of pieces of stored product information may be associated with one piece of location information. For example, it is used when a plurality of products related to a plurality of orders of the same customer are collectively arranged in one storage location.

After the association is completed, the store clerk terminal 40 can print a seal including the associated information. This seal is attached to the product. Since the seal includes the product information and the information on the storage location where the product is arranged, it is easy to return the product to the original location when the product is erroneously moved. The seal may further be printed with an arrangement date and time. In addition, after the association is completed, the store clerk terminal 40 can communicate with the electronic shelf label installed in the storage location and rewrite the display. For example, the storage status, the arrangement date and time, and a storage period are displayed.

The order management system 50 can send notifications of a delivery status and a preparation status of the product. For example, the notifications to a customer are performed when the product arrives at a designated store. In addition, the order management system 50 cooperates with the arrangement management system 10 to notify, at the time when the arrangement of the product in the storage location is completed, that a preparation for picking up the product is completed. These notifications are transmitted by a method desired by the customer, such as a smartphone app or an e-mail of the customer. As a result, the customer can grasp the status of the product in real time, and can visit the store at an appropriate timing.

When the customer visits the store, the store clerk notification unit 103 notifies the store clerk of the storage location based on the location information recorded in association with the stored product information regarding the customer. Specifically, for example, the customer visits the store, and presents a membership card and an order number on the customer terminal 30. Alternatively, the customer can verbally notify the store clerk of the order number, and the store clerk can input the order number to the POS terminal 20 or the store clerk terminal 40. Furthermore, it is also possible to photograph an image of the customer at the store and perform face authentication. By these optional methods, the store clerk notification unit 103 specifies stored product information of the corresponding customer. The store clerk notification unit 103 acquires location information associated with the specified stored product information.

In one example, the store clerk notification unit 103 displays the acquired location information on the store clerk terminal 40 or the POS terminal 20. The displayed information includes, for example, an identifier (shelf number, section number) of a storage location, a product name, a quantity, and the like. In a case where the storage location is a shelf, a diagram illustrating where the product is located on the shelf can also be displayed. For example, the position of the corresponding product is highlighted in a diagram of the shelf viewed from the front. In a large-scale store or warehouse, a map of the store or the shortest route to the storage location is displayed.

An example of a product retrieval request screen displayed on the store clerk terminal 40 or the POS terminal 20 will be described with reference to FIG. 6. This screen is displayed when a customer visits a store and wishes to pick up a stored product. The screen of FIG. 6 displays a name and membership number of the customer who visits the store. When membership information of the customer is not associated with stored product information, an order number can be displayed. In addition, an identifier indicating a location where the product is stored is displayed. Further, a product name of the product to be retrieved is displayed. Then, a current work status and an instruction are displayed. In this example, “please retrieve product” is displayed to instruct the store clerk to take a next action. When a “complete” button is pressed, the arrangement management system 10 records that the retrieval of the product is completed, and updates a stock management system as necessary.

The screen of FIG. 6 may display that the product is a reserved product and payment processing is necessary as a status. For example, in a case where both a purchased product and a reserved product are managed, statuses of these products are displayed separately.

Further, the store clerk notification unit 103 may send a notification of a storage location by lighting a light emitting device installed in the storage location. For example, when an electronic shelf label is installed in the storage location, the storage location is indicated, for example, by blinking a light emitting diode of the corresponding shelf label.

The store clerk notification unit 103 may have a function of confirming that a location code corresponding to the notified location information has been read. As a result, it is possible to reliably record that the store clerk has retrieved the product from the correct storage location. In the example of FIG. 6, for example, an instruction such as “please scan code of storage location” is displayed on the store clerk terminal 40 as a status. The store clerk notification unit 103 notifies the store clerk that a location code indicating a storage location different from the notified location information has been read. For example, a warning such as “this is not designated storage location” is displayed on the store clerk terminal 40. This function prevents the product from being retrieved from the wrong location.

The store clerk notification unit 103 may have a function of confirming that a stored product code attached to the product associated with the notified location information has been read. As a result, it is possible to record that the store clerk has retrieved the correct product. In the example of FIG. 6, for example, an instruction such as “please scan stored product code” is displayed on the store clerk terminal 40. The store clerk notification unit 103 notifies the store clerk that a stored product code indicating stored product information related to a customer different from the customer who visits the store is read. For example, a warning such as “this is not designated product” is displayed on the store clerk terminal 40. This prevents product mix-up.

At the time of retrieving the product, both the location code and the stored product code may be read. In this case, on the screen of FIG. 6, statuses such as [confirming storage location] and [confirming product] are displayed in order or simultaneously.

The store clerk notification unit 103 may display customer service support information on the store clerk terminal 40 or the POS terminal 20 at a timing when the store clerk retrieves the customer's product. The customer service support information is information for promoting sale of the stored product and information for promoting sale of a product different from the stored product. For example, the store clerk notification unit 103 displays the customer service support information at a timing when a code of a storage location is read. As a result, the store clerk can calmly prepare for serving the customer before delivering the product to the customer, at the storage location of the product. Further, the store clerk notification unit 103 may display the customer service support information at a timing when the customer who visits the store is specified (for example, a timing when a code of a membership card or the like presented by the customer is read) or at a timing when a stored product code is read.

The customer service support information includes an example of an effective customer service phrase, a wearing image of a product, an image of a usage scene, and the like. The customer service support information is generated based on customer information (name, age, sex, customer preference, purchase history, etc.), an attribute (occupation, hobby, etc.) of the customer, and detailed information such as a size and a color of a stored product. The phrase and the image may be generated by inputting the customer information and the detailed information of the product to generative artificial intelligence (AI). Such customer service support information can be utilized in various retail business categories. For example, in an apparel store, a dressing image and a coordination example of a stored product are generated. In a drugstore, makeup examples of cosmetics and effective intake methods of health foods can be presented. In a home improvement store, it is possible to display usage images of furniture and daily necessities and a layout example in a room.

The store clerk notification unit 103 may have a function of notifying a store clerk of a storage location in which a product whose storage period has expired is arranged. Specifically, for example, the store clerk notification unit 103 displays, on the store clerk terminal 40 or the POS terminal 20, location information on the product whose storage period has expired. The displayed information includes an identifier (shelf number, section number, etc.) of the storage location, a product name, a quantity, a storage start date, a storage period expiration date, and the like. In addition, in a case where there is a plurality of products whose storage period has expired, the products can be displayed in a list form and sorted by priority (for example, the order of the number of overdue days). With such a function, the store can efficiently manage the stored product and improve quality of customer service. In addition, it is possible to prevent unnecessary stock accumulation and efficiently use a store space.

Further, the store clerk notification unit 103 may have a function of determining whether a location code corresponding to location information on a product whose storage period has expired is read. As a result, it is possible to record that a store clerk actually confirms the corresponding product or performs withdrawal work. For example, when the store clerk scans a location code of the product whose storage period has expired, the system can record the work and suggest a next step (examples: delivery to customer's address, product return processing, stock rearrangement, etc.) as needed.

In addition, in a case where the withdrawal work of the product whose storage period has expired is completed, the arrangement management system 10 can also send a notification to a customer via the order management system 50. This notification includes, for example, the fact that the storage period of the product has expired, information regarding handling (examples: return, refund, transfer to another store, etc.) of the product, and a proposal of an action to be taken by the customer as necessary. The customer can also have the product delivered, by paying an additional fee.

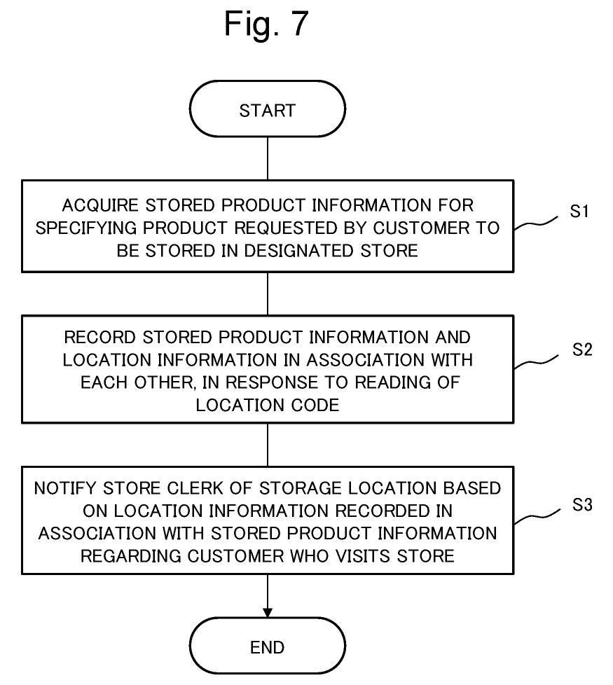

An operation example of the arrangement management system 10 of the present disclosure will be described with reference to FIG. 7. For example, the arrangement management system 10 starts a process of FIG. 7 in response to receiving an instruction to start storage work from the store clerk terminal 40, in order for a store clerk to store a product.

In step S1, the acquisition unit 101 acquires stored product information for specifying a product requested by a customer to be stored in a designated store. In step S2, in response to reading of a location code attached to a storage location of the store and indicating location information for specifying the storage location where the product is arranged, the association unit 102 records the acquired stored product information and the location information in association with each other.

Note that, in step S2, the store clerk notification unit 103 may notify the store clerk that the association has been completed. Furthermore, the association unit 102 may notify the customer that the arrangement of the product has been completed via the order management system 50.

In step S3, when the customer visits the store, the store clerk notification unit 103 notifies the store clerk of the storage location based on the location information recorded in association with the stored product information regarding the customer. Thus, the arrangement management system 10 ends the process of FIG. 7. In this way, the store clerk retrieves the product and passes the product to the customer. Then, in a case of a reserved product, payment processing is performed using the POS terminal 20.

It is required to manage information on a storage location of a product in a store in such a way that when a customer arrives at a store, the store clerk may immediately grasp the storage location and quickly provide the product. However, in the technique of JP 2023-013124 A, since the store clerk manually associates the order number with the storage opening number, the order number may be associated with a wrong storage opening number.

According to the first example embodiment, the storage location of the product can be easily managed. This is because, in response to reading of the location code indicating the location information for specifying the storage location where the product is arranged, the association unit 102 records the acquired stored product information and the location information in association with each other. This is because when the customer visits the store, the store clerk notification unit 103 notifies the store clerk of the storage location based on the location information recorded in association with the stored product information regarding the customer.

### Second Example Embodiment

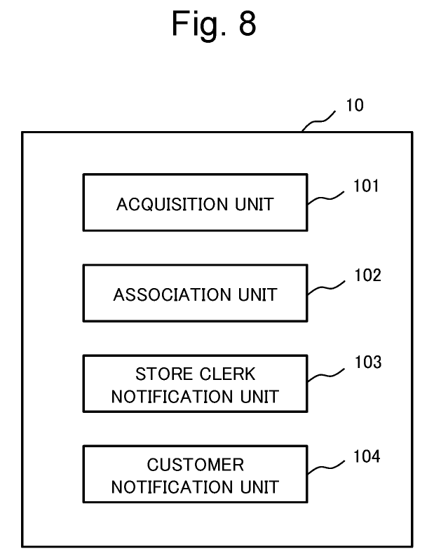

Another configuration example of an arrangement management system 10 according to the present disclosure will be described with reference to FIG. 8. The arrangement management system 10 according to the second example embodiment includes a customer notification unit 104 in addition to the configuration of the first example embodiment. In the configuration of the arrangement management system 10 according to the second example embodiment, the description of the same configuration as that of the first example embodiment will be omitted.

The customer notification unit 104 sends a notification to a customer who is visiting a store, in response to a store clerk reading a location code of a storage location of a product. This notification indicates that the store clerk has found the stored product in the store. For example, the notification is displayed on a customer terminal 30 or a customer-side display of a POS terminal 20. In response to specifying the customer who visits the store (for example, in response to reading of a code such as a membership card presented by the customer), the customer notification unit 104 transmits a message that “The product is stored. The store clerk will head to the storage location.”. Thereafter, when the store clerk retrieves the product and heads to the customer, the customer notification unit 104 transmits an additional message that “The store clerk has secured the product and will bring it to you.”. During these notifications, it is also possible to display an advertisement screen on the customer terminal 30.

The customer notification unit 104 can also provide the customer service support information as described in the first example embodiment to the customer. For example, the customer service support information generated based on stored product information is displayed on the customer terminal 30 or a customer-facing display. This information includes a method of using a product, a wearing image, a proposal for a related product, and the like.

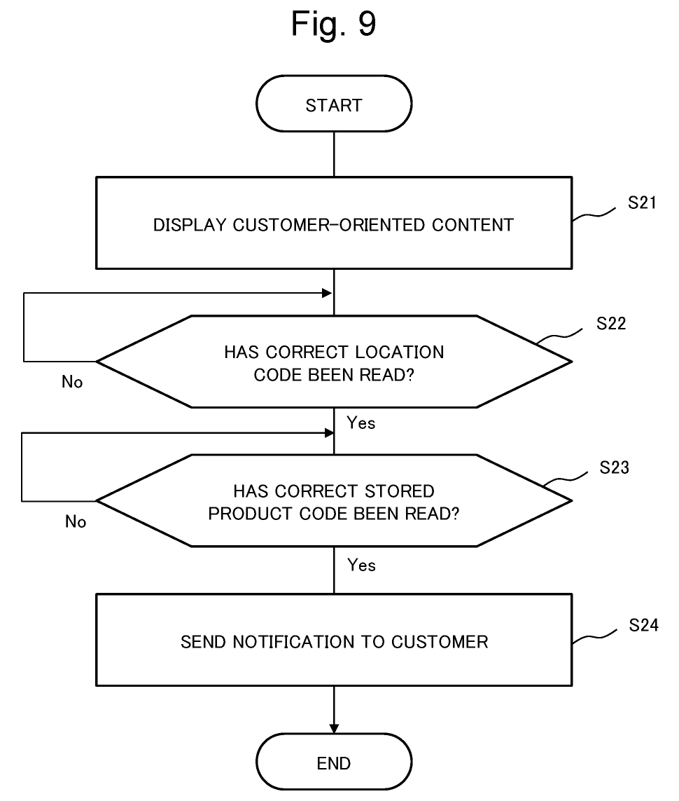

A further operation example of the arrangement management system 10 according to the present disclosure will be described with reference to FIG. 9. This processing is started, for example, in response to a customer coming to a store and reading of a customer identification code such as a membership card.

In step S21, the customer notification unit 104 displays a customer-oriented content on the customer terminal 30 or the customer-facing display in the store. This content includes an advertisement related to a product, the customer service support information described in the first example embodiment, and the like.

In step S22, a store clerk notification unit 103 determines whether a correct location code corresponding to notified location information has been read. If the correct location code has been read, the process proceeds to step S23. If not, step S22 is repeated.

In step S23, the store clerk notification unit 103 determines whether a correct stored product code has been read. If the correct stored product code has been read, the process proceeds to step S24. If not, step S23 is repeated.

In step S24, the customer notification unit 104 notifies the customer that the product has been secured. For example, a message that “The store clerk has secured the product and will bring it to you.” is transmitted to the customer terminal 30.

Thus, the arrangement management system 10 ends the process of FIG. 9. Note that the display of the customer-oriented content in step S21 is optional, and can be omitted. In addition, the configuration may be such that only one of steps S22 and S23 is executed according to a system requirement or operation policy.

According to the second example embodiment, by notifying the customer of the status of the product in real time, it is possible to reduce anxiety and dissatisfaction in waiting time of the customer. Then, the customer can grasp a preparation status of the product at any time. In addition, by displaying the customer-oriented content during the waiting time, the time of customer can be effectively utilized. This leads to improvement in customer satisfaction and creation of additional sales opportunities. Accuracy and efficiency of the store operation are improved by sending the notifications to the customer in conjunction with the work status of the store clerk (reading of the correct location code and stored product code). It is possible to prevent an erroneous product from being retrieved and delivered to the customer. Furthermore, by providing personalized customer service support information, it is possible to provide detailed services according to the needs of each customer. With these effects, quality of the customer experience in the store is greatly improved, and it is possible to simultaneously achieve the increase in the customer satisfaction level and the improvement in the efficiency of the store operation.

### Third Example Embodiment

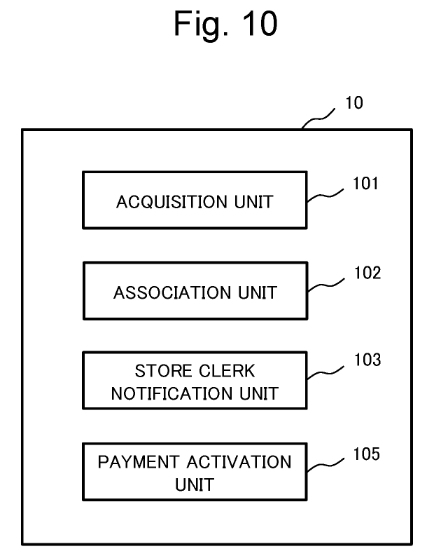

Another configuration example of an arrangement management system 10 according to the present disclosure will be described with reference to FIG. 10. The arrangement management system 10 according to the third example embodiment includes a payment activation unit 105 in addition to the configuration described in the first example embodiment. In the configuration of the arrangement management system 10 according to the third example embodiment, the description of the same configuration as that of the first example embodiment will be omitted. In the third example embodiment, the arrangement management system 10 provides a function of improving efficiency of payment processing and improving convenience for customers.

The payment activation unit 105 provides a function of enabling payment processing of a product in a case where a specific condition is satisfied. Specifically, for example, the payment processing is enabled in a case where a customer who visits a store for pickup is identified (in a case where the customer presents a pickup code such as a membership card). This makes it possible to prevent the customer from making payment before coming to the store. In addition, the payment processing is enabled in a case where a location code of a storage location of the product is read or in a case where a stored product code attached to the product is read. As a result, payment is made after the product is delivered to the customer.

First, a case where a store clerk performs an operation of the payment processing will be described. For example, when the above condition is satisfied, the payment activation unit 105 activates a payment button of a POS terminal 20 or a store clerk terminal 40. Activation refers to, for example, displaying a payment button that has not been displayed so far on a screen or changing a grayed-out button to an operable state. After activation, the store clerk can start the payment processing by pressing the payment button. The customer can make payment in cash or by electronic payment. After completion of the payment, a receipt is issued and the customer can take the product home.

In order to improve efficiency of the payment processing, information on payment means such as credit card information of the customer can be registered in an order management system 50 in advance. The payment activation unit 105 checks the presence or absence of the payment information pre-registered in the order management system 50. When the payment information is registered, the payment activation unit 105 acquires the information and transmits the information to the POS terminal 20. As a result, it is not necessary to input the payment information again at the store at the time of payment, allowing for quick processing. The POS terminal 20 executes the payment processing by using the received payment information. After completion of the payment, the POS terminal 20 transmits a payment result to the arrangement management system 10. The arrangement management system 10 records the payment completion and notifies the order management system 50 of the payment completion.

In order to enable this processing, agreement with the customer is required. For example, the agreement to the terms of use is obtained in advance at the time of ordering online. In addition, at the store, the store clerk verbally confirms to the customer that “Since you have made a reservation order on the Internet, we will proceed with payment with the registered credit card.”. Then, the store clerk presses the payment button after obtaining the agreement of the customer. When the payment button is pressed, the POS terminal 20 can issue a receipt.

Information referred to in the payment processing is displayed on a screen of the store clerk terminal 40 and the POS terminal 20. Specifically, for example, a customer name, an order number, a storage location, a product name, and a quantity are displayed. In addition, information indicating that the product is in a reserved state and payment is not completed may be included. Further, whether the payment means of the customer is registered in advance is also displayed. In these display screens, the payment activation unit 105 displays a “proceed to payment” button as the payment button.

Next, a case where the customer performs an operation of the payment processing will be described. The customer can be provided with a more quick and convenient purchase experience by making payment using the customer terminal 30 such as his/her smartphone. In this case, the payment activation unit 105 enables the payment processing on the customer terminal 30 after confirming that the store clerk has read a storage location code and a stored product code of the product.

A specific flow is as follows. First, the customer arrives at the store and presents his/her membership card and order number. The store clerk reads the storage location code and the stored product code of the corresponding product. The payment activation unit 105 activates the payment function on the customer terminal 30. Specifically, a “proceed to payment” button is displayed as the payment button together with a message that “have you received product?” on the customer terminal 30. The customer checks the product and if there is no problem, taps the “proceed to payment” button. The customer selects a payment method registered in advance or enters a new payment method to complete payment. After completion of the payment, the customer can take the product home.

With this method, the customer can make payment at his/her own pace without intervention of the store clerk, which also leads to a reduction in waiting time. In addition, an option of “not buying today” is also provided, and it is possible to cope with a case where the customer forgoes purchasing as a result of checking the product. In this case, the store clerk notification unit 103 sends a notification to the store clerk to notify that the product needs to be collected.

Since payment can be made with the store clerk terminal 40 or the customer terminal 30, the customer does not need to line up at the POS terminal 20. As a result, congestion in the store can be alleviated and the waiting time of the customer can be shortened.

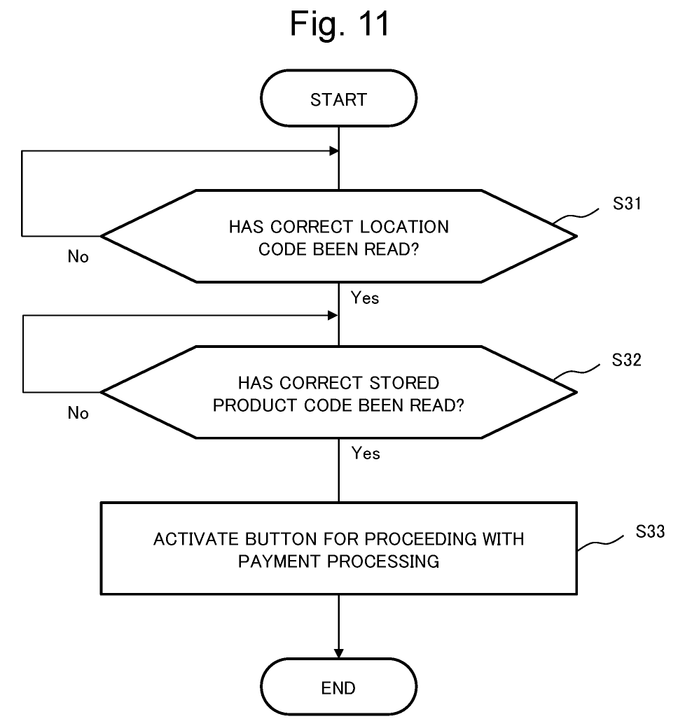

A further operation example of the arrangement management system 10 according to the present disclosure will be described with reference to FIG. 11. This processing is started, for example, in response to a customer coming to a store and reading of a customer identification code such as a membership card.

In step S31, a store clerk notification unit 103 determines whether a correct location code corresponding to notified location information has been read. If the correct location code has been read, the process proceeds to step S32. If not, step S31 is repeated.

In step S32, the store clerk notification unit 103 determines whether a correct stored product code has been read. If the correct stored product code has been read, the process proceeds to step S33. If not, step S32 is repeated. The configuration may be such that only one of steps S31 and S32 is executed according to a system requirement or operation policy.

In step S33, the payment activation unit 105 activates the payment button. Specifically, the payment button is made operable on the POS terminal 20, the store clerk terminal 40, or the customer terminal 30. As a result, the store clerk or the customer can start the payment processing.

Thus, the arrangement management system 10 ends the process of FIG. 11. In a case where the payment button is pressed, the payment processing proceeds. The arrangement management system 10 may confirm that the payment has been completed and record delivery of the product.

According to the third example embodiment, the payment activation unit 105 enables the payment processing at an appropriate timing. Therefore, the efficiency of the store operation is improved. In addition, the payment time can be greatly shortened by using the payment information registered in advance.

The example embodiments of the present disclosure have been described above. The first to third example embodiments can be appropriately combined.

### Hardware Configuration

In the above-described example embodiments, each component of the arrangement management system 10 represents a block of functional units. A part or all of each component of the arrangement management system 10 may be achieved by any combination of a computer 500 and a program.

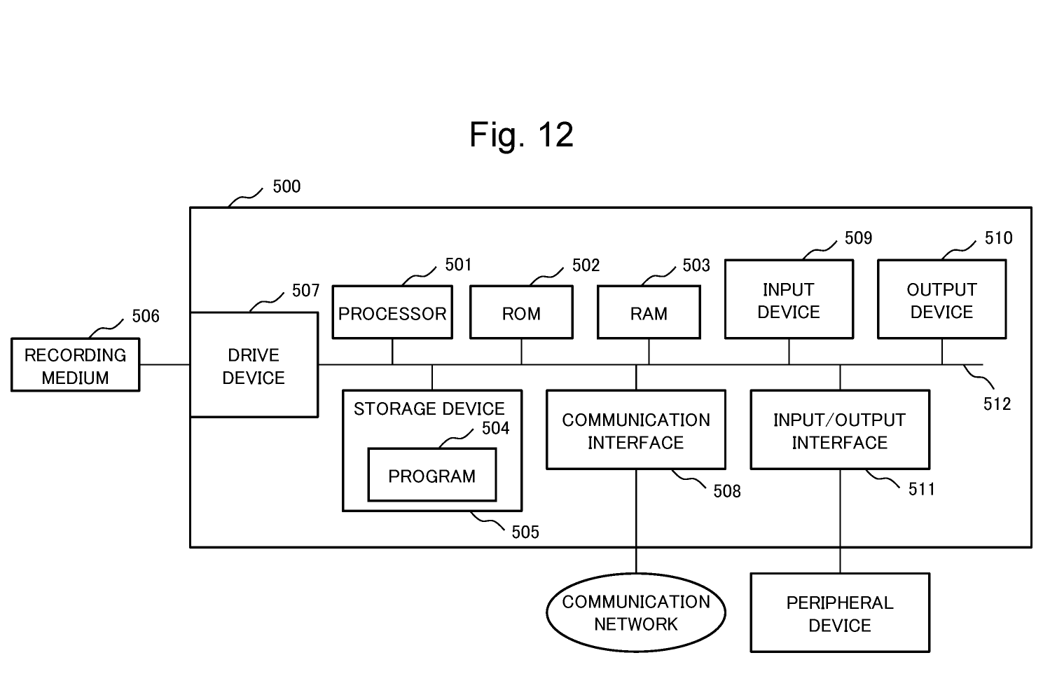

FIG. 12 is a block diagram illustrating an example of a hardware configuration of a computer 500. Referring to FIG. 12, the computer 500 includes, for example, a processor 501, a read only memory (ROM) 502, a random access memory (RAM) 503, a program 504, a storage device 505, a drive device 507, a communication interface 508, an input device 509, an output device 510, an input/output interface 511, and a bus 512.

The processor 501 controls the entire computer 500. Examples of the processor 501 include a central processing unit (CPU) and the like. The number of processors 501 is not particularly limited, and the number of processors 501 is one or more.

The program 504 includes an instruction for achieving each function of the arrangement management system 10. The program 504 is stored in advance in the ROM 502, the RAM 503, and the storage device 505. The processor 501 achieves each function of the arrangement management system 10 by executing the instructions included in the program 504. The RAM 503 may store data to be processed in each function of the arrangement management system 10.

The drive device 507 reads and writes a recording medium 506. The communication interface 508 provides an interface with a communication network. The input device 509 is, for example, a mouse, a keyboard, or the like, and receives an input of information from an administrator or the like. The output device 510 is, for example, a display, and outputs (displays) information to the administrator or the like. The input/output interface 511 provides an interface with a peripheral device. The bus 512 connects the components of the hardware. The program 504 may be supplied to the processor 501 via the communication network, or may be stored in advance in the recording medium 506, and the drive device 507 may read the program and supply the program to the processor 501.

The hardware configuration illustrated in FIG. 12 is an example, and other components may be added or some components may not be included.

There are various modifications of the implementation method of the arrangement management system 10. For example, the arrangement management system 10 may be achieved by any combination of a computer and a program different for each component. In addition, a plurality of components included in the arrangement management system 10 may be achieved by any combination of one computer and a program.

At least a part of the arrangement management system 10 may be provided in a SaaS (Software as a Service) format. That is, at least a part of the functions for achieving the arrangement management system 10 may be executed by software executed via a network.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. The configurations in the example embodiments can be combined with each other without departing from the scope of the present disclosure.

Some or all of the above example embodiments may be described as the following Supplementary Notes, but are not limited to the following.

### Supplementary Note 1

An arrangement management system including:

an acquisition means for acquiring stored product information for specifying a product requested by a customer to be stored in a designated store, when a store clerk stores the product;

an association means for recording, in response to reading of a location code indicating location information for specifying a storage location where the product is arranged among location codes respectively attached to a plurality of storage locations, the acquired stored product information and the location information in association with each other; and

a store clerk notification means for notifying the store clerk of the storage location based on the location information recorded in association with the stored product information related to the customer, when the customer visits the store.

### Supplementary Note 2

The arrangement management system according to Supplementary Note 1, further including

a customer notification means for sending a notification to the customer who is visiting the store, in response to reading of the location code attached to the notified storage location.

### Supplementary Note 3

The arrangement management system according to Supplementary Note 1 or 2, further including

a payment activation means for activating a button for proceeding with payment processing at the store of the product, in response to reading of the location code attached to the notified storage location.

### Supplementary Note 4

The arrangement management system according to any one of Supplementary Notes 1 to 3, wherein

the store clerk notification means further sends a notification of customer service support information based on the stored product information in response to reading of the location code attached to the notified storage location.

### Supplementary Note 5

The arrangement management system according to any one of Supplementary Notes 1 to 4, wherein

after the store clerk is notified of the storage location, the store clerk notification means further notifies the store clerk that a location code indicating a storage location different from the notified location information is read, in response to reading of the location code when the customer visits the store.

### Supplementary Note 6

The arrangement management system according to any one of Supplementary Notes 1 to 5, wherein

after the store clerk is notified of the storage location, the store clerk notification means further notifies the store clerk that a stored product code indicating the stored product information related to a customer different from the customer who visits the store is read, in response to reading of a stored product code attached to the product.

### Supplementary Note 7

The arrangement management system according to any one of Supplementary Notes 1 to 6, wherein

the store clerk notification means notifies the store clerk of an arrangement location where the product whose storage period has expired is arranged, and determines whether a location code corresponding to the location information of the product whose storage period has expired is read.

### Supplementary Note 8

The arrangement management system according to any one of Supplementary Notes 1 to 7, wherein

the stored product information indicates whether the product has been purchased.

### Supplementary Note 9

An arrangement management method including:

acquiring stored product information for specifying a product requested by a customer to be stored in a designated store, when a store clerk stores the product;

recording, in response to reading of a location code indicating location information for specifying a storage location where the product is arranged among location codes respectively attached to a plurality of storage locations, the acquired stored product information and the location information in association with each other; and

notifying the store clerk of the storage location based on the location information recorded in association with the stored product information related to the customer, when the customer visits the store.

### Supplementary Note 10

A program for causing a computer to execute processing of:

acquiring stored product information for specifying a product requested by a customer to be stored in a designated store, when a store clerk stores the product;

recording, in response to reading of a location code indicating location information for specifying a storage location where the product is arranged among location codes respectively attached to a plurality of storage locations, the acquired stored product information and the location information in association with each other; and notifying the store clerk of the storage location based on the location information recorded in association with the stored product information related to the customer, when the customer visits the store.

Some or all of the configurations described in Supplementary Notes 2 to 8 dependent on the above-described Supplementary Note 1 can also be dependent on Supplementary Notes 9 and 10 by the dependency relationship similar to that of Supplementary Notes 2 to 8. Some or all of the configurations described as the Supplementary Notes can be similarly dependent on not only the Supplementary Notes 1, and 9 and 10, but also various pieces of hardware and software, and various recording devices or systems for recording software without departing from the above-described example embodiments.

1. An arrangement management system comprising:
at least one memory storing instructions; and
at least one processor configured to execute the instructions to:
acquire stored product information for specifying a product requested by a customer to be stored in a designated store, when a store clerk stores the product;
record, in response to reading of a location code indicating location information for specifying a storage location where the product is arranged among location codes respectively attached to a plurality of storage locations, the acquired stored product information and the location information in association with each other; and
notify the store clerk of the storage location based on the location information recorded in association with the stored product information related to the customer, when the customer visits the store.

2. The arrangement management system according to claim 1, wherein the at least one processor is further configured to execute the instructions to:
send a notification to the customer who is visiting the store, in response to reading of the location code attached to the notified storage location.

3. The arrangement management system according to claim 1, wherein the at least one processor is further configured to execute the instructions to:
activate a button for proceeding with payment processing at the store of the product, in response to reading of the location code attached to the notified storage location.

4. The arrangement management system according to claim 1, wherein the at least one processor is further configured to execute the instructions to:
send a notification of customer service support information based on the stored product information in response to reading of the location code attached to the notified storage location.

5. The arrangement management system according to claim 1, wherein the at least one processor is further configured to execute the instructions to:
after the store clerk is notified of the storage location, notify the store clerk that a location code indicating a storage location different from the notified location information is read, in response to reading of the location code when the customer visits the store.

6. The arrangement management system according to claim 1, wherein the at least one processor is further configured to execute the instructions to:
after the store clerk is notified of the storage location, notify the store clerk that a stored product code indicating the stored product information related to a customer different from the customer who visits the store is read, in response to reading of a stored product code attached to the product.

7. The arrangement management system according to claim 1, wherein the at least one processor is further configured to execute the instructions to:
notify the store clerk of an arrangement location where the product whose storage period has expired is arranged; and
determine whether a location code corresponding to the location information of the product whose storage period has expired is read.

8. The arrangement management system according to claim 1, wherein
the stored product information indicates whether the product has been purchased.

9. An arrangement management method comprising:
acquiring stored product information for specifying a product requested by a customer to be stored in a designated store, when a store clerk stores the product;
recording, in response to reading of a location code indicating location information for specifying a storage location where the product is arranged among location codes respectively attached to a plurality of storage locations, the acquired stored product information and the location information in association with each other; and
notifying the store clerk of the storage location based on the location information recorded in association with the stored product information related to the customer, when the customer visits the store.

10. A non-transitory computer-readable recording medium storing a program for causing a computer to execute processing of:
acquiring stored product information for specifying a product requested by a customer to be stored in a designated store, when a store clerk stores the product;
recording, in response to reading of a location code indicating location information for specifying a storage location where the product is arranged among location codes respectively attached to a plurality of storage locations, the acquired stored product information and the location information in association with each other; and
notifying the store clerk of the storage location based on the location information recorded in association with the stored product information related to the customer, when the customer visits the store.

11. The arrangement management system according to claim 1, wherein
the notification to the store clerk of the storage location is performed in response to identifying the customer visiting the store by at least one of:
reading a membership card presented by the customer,
receiving an order number input by a store clerk, or
performing face authentication of the customer.
